(19) United States
(12) Patent Application Publication
(10) Pub. No.: US 2016/0261897 A1
(43) Pub. Date: Sep. 8, 2016

(54) APPARATUS AND METHOD FOR MANAGING MMT BUFFER MODEL USING RECEPTION QUALITY FEEDBACK

(71) Applicants: ELECTRONICS AND TELECOMMUNICATIONS RESEARCH INSTITUTE, Daejeon (KR); YONSEI UNIVERSITY WONJU INDUSTRY-ACADEMIC COOPERATION FOUNDATION, Wonju-si, Gangwon-do (KR)

(72) Inventors: Chang-Ki KIM, Daejeon (KR); Jeong-Ju YOO, Daejeon (KR); Jin-Woo HONG, Daejeon (KR); Kwang-Deok SEO, Wonju-si Gangwon-do (KR); Tae-Jun JUNG, Wonju-si Gangwon-do (KR)

(21) Appl. No.: 15/031,581

(22) PCT Filed: Oct. 6, 2014
(86) PCT No.: PCT/KR2014/009363

§ 371 Date: Apr. 22, 2016

(30) Foreign Application Priority Data
Oct. 23, 2013 (KR) 10-2013-0126822
Jul. 11, 2014 (KR) 10-2014-0087804

(51) Int. Cl. H04N 21/24; H04L 29/06; H04N 21/2381; H04N 21/234

(52) U.S. Cl. CPC H04N 21/2401; H04N 21/23406; H04N 21/23418; H04L 65/608; H04N 21/2381

(57) ABSTRACT

The present invention relates to a method for managing an MMT buffer model using a reception quality feedback (RQF) message from an MMT reception entity, comprising the steps of: receiving, from an MMT transmission entity, a measurement configuration (MC) message; measuring maximum transmission delay and minimum transmission delay, according to a request by the MC message that is received; renewing an RQF message including the maximum transmission delay and minimum transmission delay that have been measured; and transmitting the renewed RQF message to the MMT transmission entity.

### TECHNICAL FIELD

The following description generally relates to a technology for providing a media transport service based on a Moving Picture Experts Group (MPEG) media transport system, and more particularly to an apparatus and method for managing an MPEG Media Transport (MMT) buffer model.

### BACKGROUND ART

An MPEG Media Transport (MMT) is a new media transport standard technology that has been developed since 2010 by a system sub-working group of an ISO/IEC WG11 (MPEG).

The conventional MPEG-2 system has standardized an MPEG-2 transport stream (TS) technology as a standard for functions of packetization, synchronization, multiplexing, and the like, which are required to transfer audio/video (AV) content in a broadcast network, and the technology is being widely used. However, the MPEG-2 TS is inefficient in a packet transfer environment with an Internet Protocol (IP)-based network.

Thus, in consideration of a new media transfer environment and a future media transfer environment, the ISO/IEC WG 11 MPEG recognizes a need for a new media transfer standard, and starts MMT standardization.

In an MMT system, a Hypothetical Receiver Buffer Model (HRBM) is adopted to provide media transport service while preventing underflow and overflow of a receiving entity buffer. In the HRBM, parameters that are essential for management of a receiving entity buffer are transmitted from a sending entity through an HRBM message, and based on the provided parameters, an appropriate buffer size and duration of remaining in a receiving entity buffer are controlled. However, the MMT technology to be approved by the Draft for International Standard (DIS) does not specify a device or method of accurately estimating some of the parameter values.

### TECHNICAL PROBLEM

The present invention provides an apparatus and method for managing an MMT buffer model, in which by using an RQF message, parameters may be provided that are necessary for improving accuracy of managing a Hypothetical Receiver Buffer Model (HRBM) included in the current MMT technology.

### TECHNICAL SOLUTION

In one general aspect, there is provided a method of managing an MPEG Media Transport (MMT) buffer model using a reception quality feedback (RQF) message in an MMT receiving entity, the method including: receiving a measurement configuration (MC) message is from an MMT sending entity; measuring a maximum transmission delay and a minimum transmission delay in response to a request of the received MC message; updating an RQF message that includes the measured maximum transmission delay and minimum transmission delay; and transmitting the updated RQF message to the MMT sending entity.

In another general aspect, there is provided a method of managing an MPEG Media Transport (MMT) buffer model using a reception quality feedback (RQF) message in an MMT sending entity, the method including: transmitting a measurement configuration (MC) message to an MMT receiving entity; receiving from the MMT receiving entity the RQF message that includes a maximum transmission delay and a minimum transmission delay; calculating a fixed end-to-end transmission delay and a buffer size by using the maximum transmission delay and the minimum transmission delay; and including the calculated fixed end-to-end transmission delay and buffer size in a buffer control message to transmit the message to the MMT receiving entity.

In still another general aspect, there is provided an apparatus for managing an MPEG Media Transport (MMT) buffer model using a reception quality feedback (RQF) message, the apparatus including: an MC message receiver configured to receive a measurement configuration (MC) message from an MMT sending entity; a delay measuring component configured to measure a maximum transmission delay and a minimum transmission delay in response to a request included in the received MC message; a feedback message updater configured to update the RQF message that includes the measured maximum transmission and minimum transmission delay; and a feedback message transmitter configured to transmit the updated RQF message to the MMT sending entity.

In yet another general aspect, there is provided an apparatus for managing an MPEG Media Transport (MMT) buffer model using a reception quality feedback (RQF) message, the apparatus including: an MC message transmitter configured to transmit a measurement configuration (MC) message to an MMT receiving entity; a feedback message receiver configured to receive from the MMT receiving entity the RQF message that includes a maximum transmission delay and a minimum transmission delay; a buffer control information calculator configured to calculate a fixed end-to-end transmission delay and a buffer size by using the maximum transmission delay and the minimum transmission delay; and a receiving buffer control message transmitter configured to include the calculated fixed end-to-end transmission delay and buffer size in a receiving buffer control message to transmit the message to the MMT receiving entity.

### ADVANTAGEOUS EFFECTS

The present invention may minimize errors in management of a receiving entity buffer, which may occur due to inaccurate estimates and calculations of HRBM. More specifically, according to the present invention, an accurate buffer size required for an MMT receiving entity, and an accurate buffering delay time of received data may be determined, such that an HRBM system may be operated without causing the MMT receiving entity buffer to underflow or overflow.

### DESCRIPTION OF DRAWINGS

FIG. 1 is a diagram illustrating a protocol stack that includes functional areas of an MMT system.

FIG. 2 is a signal flowchart explaining a method of managing an MMT buffer model using an RQF message according to an exemplary embodiment.

FIG. 3 is a diagram illustrating an MMT sending entity according to an exemplary embodiment.

FIG. 4 is a diagram illustrating an MMT receiving entity according to an exemplary embodiment.

FIG. 5 is a diagram explaining a method of managing an MMT buffer model using an RQF message in an MMT receiving entity according to an exemplary embodiment.

FIG. 6 is a flowchart explaining a method of managing an MMT buffer model using an RQF message in an MMT sending entity according to an exemplary embodiment.

### MODE FOR INVENTION

The present invention will now be described more fully with reference to the accompanying drawings, in which exemplary embodiments of the invention are shown. Hereinafter, in describing the present invention, detailed descriptions of relevant functions or structures well-known to those skilled in the art will be omitted when it is considered that the descriptions obscure the point of the present invention. Further, the terms used throughout this specification are defined in consideration of functions according to exemplary embodiments, and may be varied depending on intensions of a user or a manager, or precedent, and so on. Therefore, definitions of the terms should be made on the basis of the overall context.

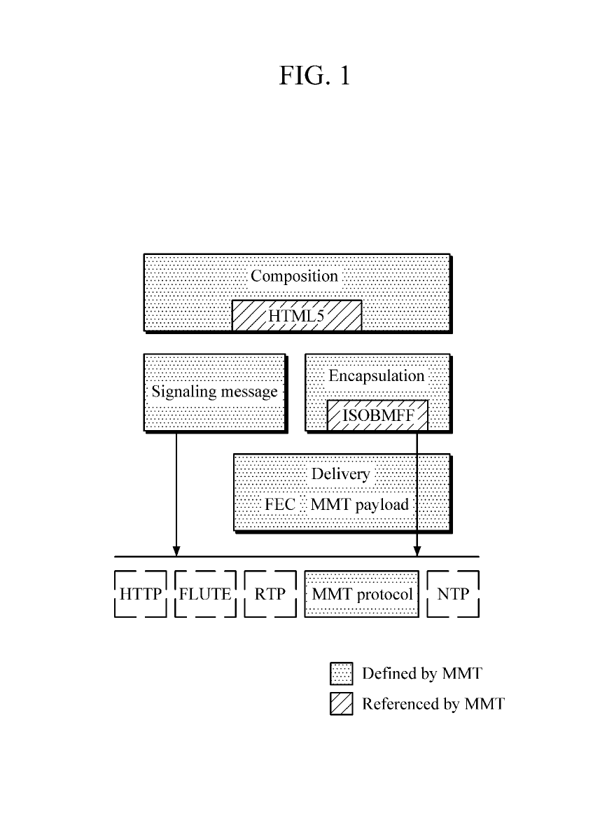

FIG. 1 is a diagram illustrating a protocol stack that includes functional areas of an MMT system.

Referring to FIG. 1, an MMT layer includes four functional areas of an encapsulation layer, a delivery layer, a signaling layer, and a composition layer.

The encapsulation layer may have functions of packetization, fragmentation, synchronization, multiplexing, and the like, of transported media. The delivery layer may have functions of network flow multiplexing, network packetization, QoS control, and the like, of media transported through a network.

The signaling layer may generate information required for representation and consumption of media, generate control information required for optimization of transfer quality, and transmit the generated information using an MMT protocol, or a separate signaling means.

The composition layer may record composition information that represents a spatio-temporal relationship between Asset and Package, which are generated in an encapsulation layer. Such MMT system adopts an HRBM to provide a media transport service without causing an MMT receiving entity buffer to underflow or overflow.

In the HRBM, an MMT sending entity transmits parameters required for management of an MMT receiving entity buffer through an HRBM signaling message.

Table 1 shows a structure of an HRBM signaling message format.

TABLE 1

| Syntax | Values | No. of bits | Mnemonic |
|---|---|---|---|
| HRBM ( ){ | | | |
| message_id | | 16 | |
| version | | 8 | |
| length | | 16 | |
| extension { | | | |
| extension_fields_Byte | | | |
| } | | | |
| message_payload{ | | | |
| max_buffer_size | | 32 | |
| fixed_end_to_end_delay | | 32 | |
| max_transmission_delay | | 32 | |
| } | | | |
| } | | | |

Referring to Table 1 above, in order to control a size and operations of an MMT receiving entity buffer, types of parameters transmitted by an MMT sending entity include a maximum buffer size (max_buffer size), a fixed end-to-end transmission delay, and a maximum transmission delay (max_transmission_delay).

Based on the three parameters, an MMT receiving entity may determine an appropriate buffer size of an MMT receiving entity, and may control duration of received data remaining in the buffer.

The fixed end-to-end transmission delay may be calculated by the following Equation 1, and the maximum buffer size (max_buffer size) may be calculated by the following Equation 2.

fixed_end_to_end_delay=maximum_transmission_delay+FEC_buffering_time [Equation 1]

max_buffer_size=(maximun_transmission_delay-minimum_transmission_delay)*maximum_bitrate [Equation 2]

The maximum transmission delay (max_transmission_delay) and the minimum transmission delay (min_transmission_delay) are the most important parameters to accurately calculate the fixed end-to-end transmission delay and the maximum buffer size (max_buffer size) by using Equation 1 and Equation 2.

An MMT technology to be approved by the DIS does not specify a device or method of accurately estimating values of the maximum transmission delay (max_transmission_delay) and the minimum transmission delay (min_transmission_delay). Accordingly, in order to improve accuracy of managing an HRBM in the current MMT technology, the maximum transmission delay (max_transmission_delay) and the minimum transmission delay (min_transmission_delay) is are required to be accurately estimated.

Regarding a media transport quality in the MMT technology, various types of information used in an MMT receiving entity may be provided to an MMT sending entity. Specifically, an MMT receiving entity may transmit a reception quality feedback (RQF) message to an MMT sending entity.

Table 2 shows a structure of an RQF message.

TABLE 2

| | | No. | |
|---|---|---|---|
| Syntax | Values | of bits | Mnemonic |
| RQF_message ( ) { | | 16 | |
| | | 8 | |
| message_id | | 16 | |
| version | | | |
| length | | | |
| message_payload { | | | |
| measurement_duration | | 16 | unsigned short |
| packet_loss_ratio | | 8 | unsigned char |
| inter_arrival_jitter | | 32 | unsigned integer |
| RTT_parameter( ) { | | | |
| propagation_delay | | 32 | unsigned integer |
| feedback_timestamp | | 32 | unsigned integer |
| } | | | |
| } | | | |
| } | | | |

Referring to Table 2 above, information provided from an MMT receiving entity to an MMT sending entity through an RQF message include a packet loss ratio (packet_loss_ratio), a network jitter, and an average propagation delay. In the present disclosure, it is suggested that values of the maximum transmission delay (max_transmission_delay) and the minimum transmission delay (min_transmission_delay) used in Equation 1 and Equation 2 are provided from an MMT receiving entity to an MMT sending entity.

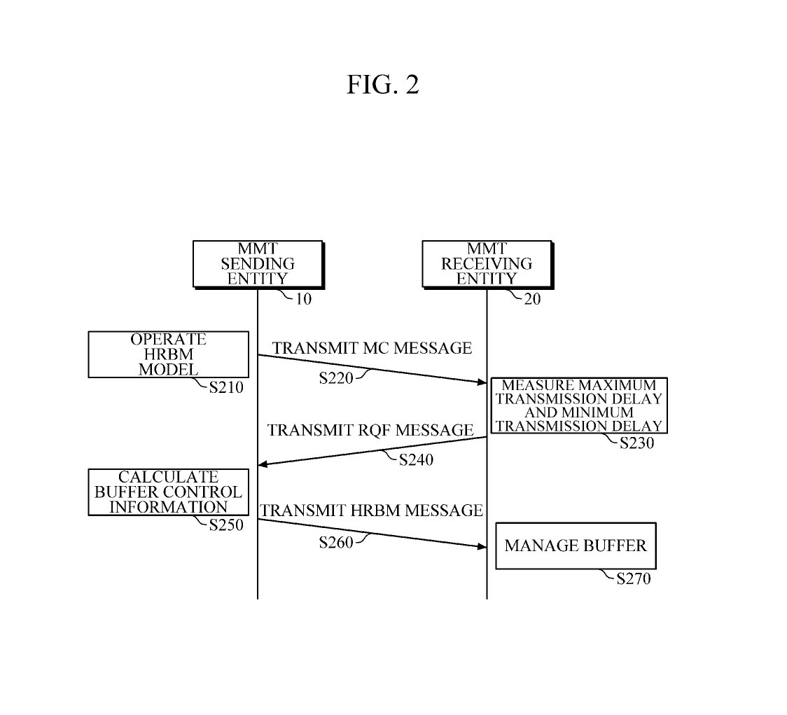

FIG. 2 is a signal flowchart explaining a method of managing an MMT buffer model using an RQF message according to an exemplary embodiment.

Referring to FIG. 2, an MMT sending entity 10 operates an HRBM model in S210, and transmits a measurement configuration (MC) message in S220. In the MMT system, the MMT sending entity transmits a measurement configuration (MC) message to an MMT receiving entity to transmit a request for various measurements of a transmitted packet to the MMT receiving entity. That is, according to an exemplary embodiment of the present disclosure, the maximum transmission delay (max_transmission_delay) and the minimum transmission delay (min_transmission_delay) are requested to be measured.

Subsequently, an MMT receiving entity 20 measures the maximum transmission delay (max_transmission_delay) and the minimum transmission delay (min_transmission_delay) in S230. The MMT receiving entity 20 transmits to the MMT sending entity 10 an RQF message in S240 that includes the maximum transmission delay (max_transmission_delay) and the minimum transmission delay (min_transmission_delay).

In packet transmission based on an MMT system, a total delay time required for packet transmission may be calculated in such a manner that information on coordinated universal time (UTC) for a packet transmission time is recorded in a packet header as a network time protocol timestamp value, and the MMT receiving entity measures an NTP time corresponding to UTC of a receiving time.

In the present disclosure, among transmission delay values obtained by real measurement in this manner, a maximum value and a minimum value are recorded in an RQF message so that the MMT receiving entity may transmit the values to an MMT sending entity. The maximum value and the minimum value refer to a maximum value and a minimum value measured in a measurement duration section predetermined for arriving packets.

Table 3 shows a structure of an RQF message improved according to an exemplary embodiment of the present disclosure, in which information on a maximum transmission delay and a minimum transmission delay are newly added.

TABLE 3

| | | No. | |
|---|---|---|---|
| Syntax | Values | of bits | Mnemonic |
| RQF_message ( ) { | | 16 | |
| | | 8 | |
| message_id | | 16 | |
| version | | | |
| length | | | |
| message_payload { | | | |
| measurement_duration | | 16 | unsigned short |
| packet_loss_ratio | | 8 | unsigned char |
| inter_arrival_jitter | | 32 | unsigned integer |
| max_transmission_delay | | 32 | unsigned integer |
| min_transmission_delay | | 32 | unsigned integer |
| RTT_parameter( ) { | | | |
| propagation_delay | | 32 | unsigned integer |
| feedback_timestamp | | 32 | unsigned integer |
| } | | | |
| } | | | |
| } | | | |

Syntax that shows a maximum transmission delay is represented as max_transmission_delay (32 bits), and syntax that shows a minimum transmission delay is represented as min_transmission_delay (32 bits).

Then, the MMT sending entity 10 may calculate a fixed end-to-end transmission delay and a buffer size in S250 by using the maximum transmission delay and the minimum transmission delay included in the RQF message provided from the MMT receiving entity 20. That is, the MMT sending entity 10 may calculate a fixed end-to-end transmission delay and a buffer size by using Equation 1 and Equation 2 and using the maximum transmission delay and the minimum transmission delay included in the RQF message provided from the MMT receiving entity 20.

Further, the calculated values of a fixed end-to-end transmission delay and a buffer size are included in an HRBM message format to be transmitted in S260 to the MMT receiving entity 20.

The MMT receiving entity 20 may manage a receiving buffer in S270 by using the values of a fixed end-to-end transmission delay and a buffer size included in an HRBM message.

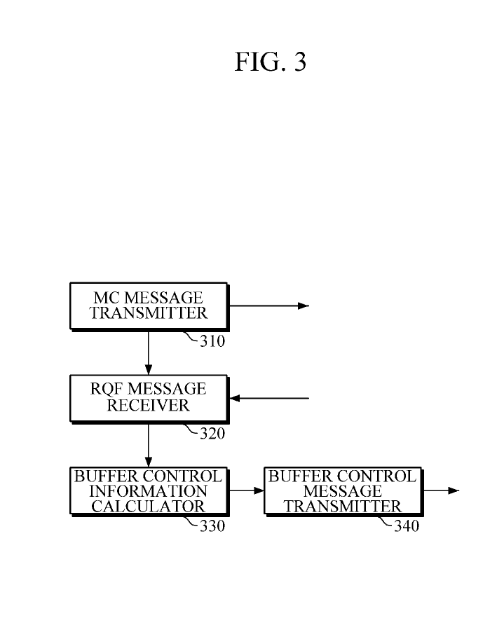

FIG. 3 is a diagram illustrating an MMT sending entity according to an exemplary embodiment.

Referring to FIG. 3, the MMT sending entity 10 includes an MC message transmitter 310, an RQF message receiver 320, a buffer control information calculator 330, and a buffer control message transmitter 340.

The MC message transmitter 310 transmits a measurement configuration (MC) message to the MMT receiving entity 20. In the MMT system, the MMT sending entity transmits an MC message to the MMT receiving entity to transmit a request for various measurements of a transmitted packet to the MMT receiving entity. That is, according to an exemplary embodiment of the present disclosure, the maximum transmission delay (max_transmission_delay) and the minimum transmission delay (min_transmission_delay) are requested to be measured.

The RQF message receiver 320 receives from the MMT receiving entity 20 an RQF message that includes the maximum transmission delay (max_transmission_delay) and the minimum transmission delay (min_transmission_delay). The buffer control information calculator 330 may calculate a fixed end-to-end transmission delay and a buffer size by using the maximum transmission delay (max_transmission_delay) and the minimum transmission delay (min_transmission_delay) included in the RQF message provided from the MMT receiving entity 20. The calculation is performed by using Equation 1 and Equation 2. The buffer control message transmitter 340 may include the calculated fixed end-to-end transmission delay and buffer size in an HRBM message and transmit the message to the MMT receiving entity 20.

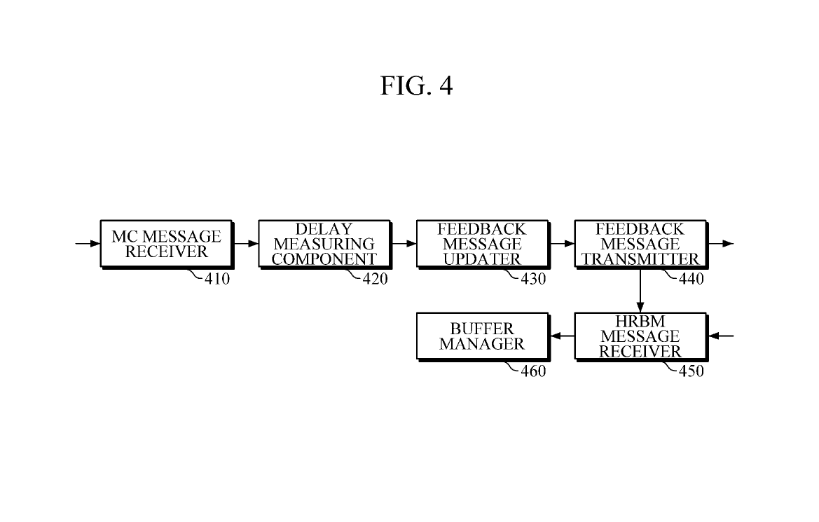

FIG. 4 is a diagram illustrating an MMT receiving entity according to an exemplary embodiment.

Referring to FIG. 4, an MC message receiver 410 receives an MC message from the MMT sending entity 10.

A delay measuring component 420 measures a maximum transmission delay (max_transmission_delay) and a minimum transmission delay (min_transmission_delay) in response to a request included in a received MC message.

In packet transmission based on an MMT system, a total delay time required for packet transmission may be calculated in such a manner that information on coordinated universal time (UTC) for a packet transmission time is recorded in a packet header as a network time protocol timestamp value, and the MMT receiving entity measures an NTP time corresponding to the UTC of a receiving time. In the present disclosure, among transmission delay values obtained by real measurement in this manner, a maximum value and a minimum value are recorded in an RQF message so that the MMT receiving entity may transmit the values to an MMT sending entity. The maximum value and the minimum value refer to a maximum value and a minimum value measured in a measurement duration section predetermined for arriving packets.

A feedback message updater 430 updates an RQF message that includes a measured maximum transmission delay (max_transmission_delay) and minimum transmission delay (min_transmission_delay). In the RQF message according to an exemplary embodiment, syntax that shows a maximum transmission delay is represented as max_transmission_delay (32 bits), and syntax that shows a minimum transmission delay is represented as min_transmission_delay (32 bits), as illustrated in Table 3 above.

A feedback message transmitter 440 may transmit an updated RQF message to the MMT sending entity 10.

An HRBM message receiver 450 may receive from the MMT sending entity 10 an HRBM message that includes a fixed end-to-end transmission delay and a buffer size value, and a buffer manager 460 may manage a received buffer by using the fixed end-to-end transmission delay and buffer size value included in the message.

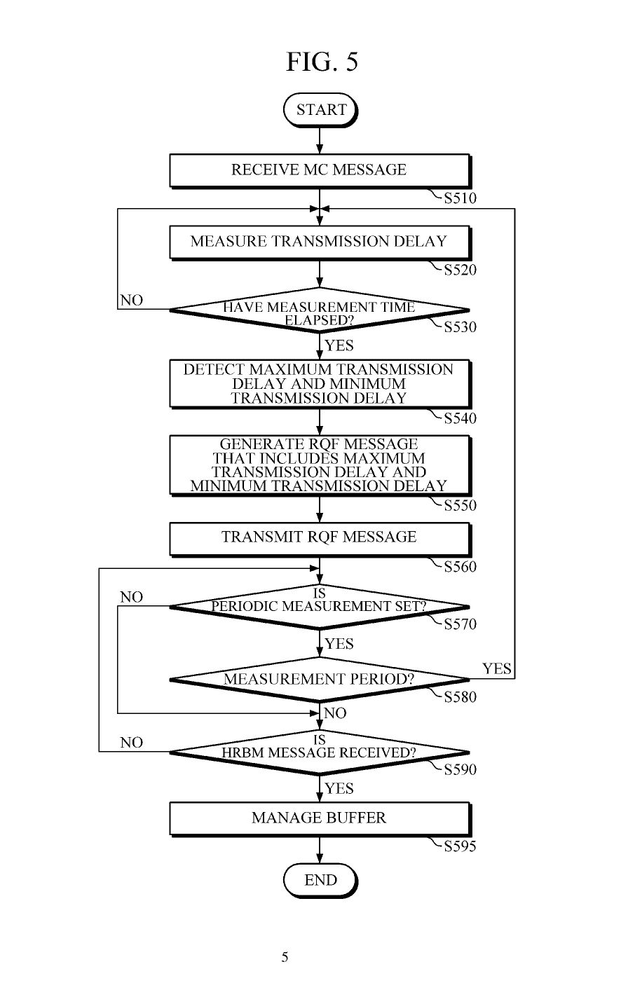

FIG. 5 is a diagram explaining a method of managing an MMT buffer model using an RQF message in an MMT receiving entity according to an exemplary embodiment.

Referring to FIG. 5, the MMT receiving entity 20 receives an MC message in S510 from the MMT sending entity 10. That is, through the received MC message, a maximum transmission delay (max_transmission_delay) and a minimum transmission delay (min_transmission_delay) are requested to be measured.

The MMT receiving entity measures a total delay time required for packet transmission in S520 by measuring an NTP time corresponding to UTC of a receiving time.

The MMT receiving entity 20 measures a transmission delay during a predetermined time section, in which it is determined whether a specific measurement time elapses in S530.

If it is determined that a specific measurement time elapses in S530, the receiving entity 20 selects a maximum value and a minimum value in S540 among transmission delay values obtained by the measurement.

The MMT receiving entity 20 generates an RQF message in S550 that includes a maximum transmission delay (max_transmission_delay) and a minimum transmission delay (min_transmission_delay), and transmits the generated RQF message to the MMT sending entity 10 in S560.

The MC message received in S510 may have a time section set for measurement, in which measurement may be requested once or periodically. In the case where a time section is predetermined to be measured periodically, a maximum transmission delay (max_transmission_delay) and a minimum transmission delay (min_transmission_delay) are required to be obtained for each measurement section, and the MMT receiving entity includes measurement results in an RQF message and periodically transmits the message to the MMT sending entity.

That is, the MMT receiving entity 20 determines whether a time section for periodic measurement is set in S570, and in the case whether a time section for measurement is periodically set, the MMT receiving entity 20 determines in S580 whether the time section is within a measurement period. If it is determined that the time section is a measurement period, the MMT receiving entity 20 proceeds to S520.

The MMT receiving entity 20 determines in S590 whether an HRBM message, which is a receiving buffer control message, is received or not.

Upon determination in S590, if it is determined that an HRBM message is received, the MMT receiving entity 20 manages a receiving buffer in S595 by using a fixed end-to-end transmission delay and a buffer size value included in the HRBM message.

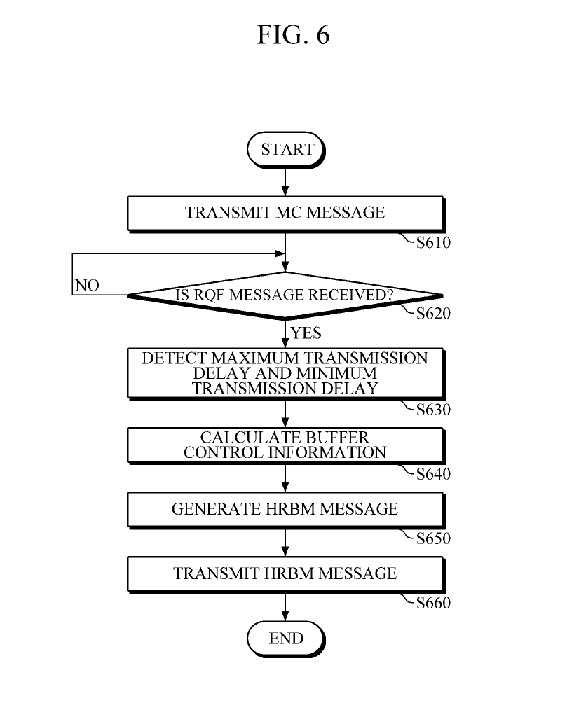

FIG. 6 is a flowchart explaining a method of managing an MMT buffer model using an RQF message in an MMT sending entity according to an exemplary embodiment.

Referring to FIG. 6, the MMT sending entity 10 transmits an MC message to the MMT receiving entity 20 in S610. The MC message may include a request to measure a maximum transmission delay (max_transmission_delay) and a minimum transmission delay (min__transmission_delay), and the periodic measurement may be requested.

The MMT sending entity 10 determines whether an RQF message, which includes a maximum transmission delay (max_transmission_delay) and a minimum transmission delay (min_transmission_delay), is received from the MMT receiving entity 20 in S620.

Upon determination in S620, if an RQF message is received, the MMT sending entity 10 detects a maximum transmission delay (max_transmission_delay) and a minimum transmission delay (min_transmission_delay) included in the received RQF message in S630, to calculate a fixed end-to-end transmission delay and a buffer size in S640.

Then, the MMT sending entity 10 includes, in S650, the calculated fixed end-to-end transmission delay and buffer size value in an HRBM that is a receiving buffer control message, and transmits the message to the MMT receiving entity 20 in S660.

1. A method of managing an MPEG Media Transport (MMT) buffer model using a reception quality feedback (RQF) message in an MMT receiving entity, the method comprising:
receiving a measurement configuration (MC) message from an MMT sending entity;
measuring a maximum transmission delay and a minimum transmission delay in response to a request of the received MC message;
updating an RQF message that includes the measured maximum transmission delay and minimum transmission delay; and
transmitting the updated RQF message to the MMT sending entity.

2. The method of claim 1, wherein the measuring comprises:
measuring a total delay time required for packet transmission by measuring a Network Time Protocol (NTP) time corresponding to Coordinated Universal Time (UTC) of a receiving time; and
selecting the maximum transmission delay and the minimum transmission delay among one or more transmission delay values obtained by the measurement.

3. The method of claim 1, wherein the maximum transmission delay and the minimum transmission delay refer to a maximum value and a minimum value among transmission delay values measured in a measurement duration section predetermined for arriving packets.

4. The method of claim 1, wherein the maximum transmission delay and the minimum transmission delay are recorded in a 32-bit field.

5. The method of claim 1, further comprising:
receiving from the MMT sending entity a buffer control message that includes a fixed end-to-end transmission delay and a buffer size; and
managing a buffer by using the fixed end-to-end transmission delay and the buffer size.

6. A method of managing an MPEG Media Transport (MMT) buffer model using a reception quality feedback (RQF) message in an MMT sending entity, the method comprising:
transmitting a measurement configuration (MC) message to an MMT receiving entity;
receiving from the MMT receiving entity the RQF message that includes a maximum transmission delay and a minimum transmission delay;
calculating a fixed end-to-end transmission delay and a buffer size by using the maximum transmission delay and the minimum transmission delay; and
including the calculated fixed end-to-end transmission delay and buffer size in a buffer control message to transmit the message to the MMT receiving entity.

7. The method of claim 6, wherein the calculating comprises calculating the fixed end-to-end transmission delay by adding a buffering time to the maximum transmission delay.

8. The method of claim 6, wherein the calculating comprises calculating the buffer size by subtracting the minimum transmission delay from the maximum transmission delay, and by multiplying an obtained value by a maximum bit rate.

9. An apparatus for managing an MPEG Media Transport (MMT) buffer model using a reception quality feedback (RQF) message, the apparatus comprising:
an MC message receiver configured to receive a measurement configuration (MC) message from an MMT sending entity;
a delay measuring component configured to measure a maximum transmission delay and a minimum transmission delay in response to a request included in the received MC message;
a feedback message updater configured to update the RQF message that includes the measured maximum transmission and minimum transmission delay; and
a feedback message transmitter configured to transmit the updated RQF message to the MMT sending entity.

10. The apparatus of claim 9, wherein the delay measuring component measures a total delay time required for packet transmission by measuring a Network Time Protocol (NTP) time corresponding to Coordinated Universal Time (UTC) of a receiving time, and selects the maximum transmission delay and the minimum transmission delay among one or more transmission delay values obtained by the measurement.

11. The apparatus of claim 9, wherein the maximum transmission delay and the minimum transmission delay refer to a maximum value and a minimum value among transmission delay values measured in a measurement duration section predetermined for arriving packets.

12. The apparatus of claim 9, wherein the maximum transmission delay and the minimum transmission delay are recorded in a 32-bit field.

13. The apparatus of claim 9, further comprising:
a buffer control message receiver configured to receive from the MMT sending entity a buffer control message that includes a fixed end-to-end transmission delay and a buffer size; and
a buffer manager configured to manage a buffer by using the fixed end-to-end transmission delay and the buffer size.

14. An apparatus for managing an MPEG Media Transport (MMT) buffer model using a reception quality feedback (RQF) message, the apparatus comprising:
an MC message transmitter configured to transmit a measurement configuration (MC) message from an MMT receiving entity;
a feedback message receiver configured to receive from the MMT receiving entity the RQF message that includes a maximum transmission delay and a minimum transmission delay;
a buffer control information calculator configured to calculate a fixed end-to-end transmission delay and a buffer size by using the maximum transmission delay and the minimum transmission delay; and
a receiving buffer control message transmitter configured to include the calculated fixed end-to-end transmission delay and buffer size in a receiving buffer control message to transmit the message to the MMT receiving entity.

15. The apparatus of claim 14, wherein the buffer control information calculator calculates the fixed end-to-end transmission delay by adding a buffering time to the maximum transmission delay.

16. The apparatus of claim 14, wherein the buffer control information calculator calculates the buffer size by subtracting the minimum transmission delay from the maximum transmission delay, and by multiplying an obtained value by a maximum bit rate.
